(19) United States
(12) Patent Application Publication
(10) Pub. No.: US 2026/0287363 A1
(43) Pub. Date: Sep. 24, 2026

(54) DETECTING INACCURACIES IN CARRIER LOCATION DATA OF A VESSEL

(71) Applicant: WISETECH GLOBAL (LICENSING) PTY LTD, Alexandria (AU)

(72) Inventors: Igor NUZHNOV, Alexandria (AU); Dmitry KISLOV, Alexandria (AU)

(21) Appl. No.: 19/475,883

(22) PCT Filed: Apr. 10, 2024
(86) PCT No.: PCT/AU2024/050341

§ 371 Date: Oct. 16, 2025

(30) Foreign Application Priority Data
Apr. 18, 2023 (AU) 2023202360

(51) Int. Cl. G01C 21/20; G01C 21/00; G01S 19/39

(52) U.S. Cl. CPC G01C 21/203; G01C 21/3804; G01S 19/396

(57) ABSTRACT

This disclosure relates to automatically detecting inaccuracies in carrier location data of a vessel. A processor receives the carrier location data generated by a carrier and comprising multiple location data elements indicative of a port at which the vessel has berthed. The processor also receives historical vessel location data comprising vessel location coordinates. Then, the processor matches the historical vessel location data with a predefined list of port locations, to generate validation data comprising validation data elements indicative of a match between the vessel location coordinates and the port locations. The processor further determines a numerical correspondence value between carrier location data elements and validation data elements. Based on the correspondence, the processor identifies discrepancies between the carrier location data and the validation data to automatically detect the inaccuracies in the carrier location data.

### TECHNICAL FIELD

This disclosure relates to automatically detecting inaccuracies in carrier location data of a vessel.

### BACKGROUND

Vessel tracking relates to capturing a geographic location of a vessel over time. This can be achieved by global positioning system (GPS) receivers installed on vessels. These receivers may be connected to a radio communication system to transmit the captured GPS location periodically to a data network. One such example is the Advanced Information System (AIS), which broadcasts a vessel's GPS location over radio so that other vessels in the vicinity can receive the GPS location and determine whether there is a risk of collision.

Since the AIS signal is broadcast without encryption, it can be received by non-moveable land-based stations (or satellites) that continuously collect the location data of many vessels to generate a dataset that is representative of current and historical locations of most larger vessels globally.

While the GPS location is relatively accurate and reflects the current location of the vessel well, it is also meaningless in relation to other geographical features. For example, the GPS location does not provide information on whether a vessel is in a particular area or on a particular path. Even further, the captured historical GPS location enables the generation and visualisation of a vessel's track across the globe, but it does not provide a meaningful sequence of areas or ‘places’ that the vessel has visited.

One example for areas or places that vessels visit are ports. It is important to determine the correct sequence of ports for a vessel because such a sequence would provide more meaningful tracking of the vessel as to the ports at which the vessel has berthed and in what sequence the vessel has berthed at these ports.

When cargo is transported from an initial pick-up location to a final delivery location, this typically involves a number of parties. For example, a freight forwarder organises shipments for individuals or corporations to get cargo from a manufacturer to a market. Freight forwarders contract with a carrier or often multiple carriers to move the cargo from one country to another. A freight forwarder does not move the goods but acts as an expert in the logistics network. The carriers can use a variety of shipping modes, including ships, airplanes, trucks, and railroads, and often use multiple modes for a single shipment. For example, the freight forwarder may arrange to have cargo moved from a plant to an airport by truck, flown to the destination city and then moved from the airport to a customer's building by another truck.

For ocean transport, a carrier agent deals with all the commercial activities in and around the shipping line. They oversee the booking of containers and vessel slots, make sure the bill of lading is issued, and so on. In contrast, a vessel agent controls and handles the operations on a vessel. So it is the vessel agent that has access to the most accurate information about the vessels arrival and departure in various different ports. However, the freight forwarder may wish to also have access to that data. Since the carrier forwards the data between the vessel agent and the freight forwarder, the processes of capture and transmission of vessel location data is often not very effective. As a result, the data received by the freight forwarder often has inaccuracies. For example, the names used for ports may be inconsistent or the order in which the ports have been visited by the vessel is incorrect. For example, in the Mediterranean the distance between ports is typically short so a vessel may repeat the same loop of ports multiple times and some visited ports can be close to each other, which often makes the carrier's list of port calls inaccurate. A further example is Norway where vessels enter every fjord and some ports with different UNLOCO code mean the same port and there may be two different ports with the same town name (e.g. Oslo). Further, AIS may not be available during parts of a vessel's trip where the vessel is outside range of land-based AIS receivers.

Therefore, there is a need for a solution that can detect inaccuracies in the carrier location data of a vessel.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

This disclosure provides a method for matching two lists against each other. These two lists include the list of port names from the carrier, which may be unsorted, incorrectly sorted, include incorrect port names etc. The second list is the list of ports from the location (GPS/AIS) data, which again may have inaccuracies. The method determines multiple matches between elements of both lists and finds the best match to determine the correct sorting of the list port names from the carrier.

A method for automatically detecting inaccuracies in carrier location data of a vessel comprises:
receiving the carrier location data generated by a carrier and comprising multiple location data elements, each of the multiple location data elements being indicative of a port at which the vessel has berthed;
receiving historical vessel location data, generated by the vessel using a location sensor on the vessel and comprising vessel location coordinates;
matching the historical vessel location data with a predefined list of port locations, to generate validation data comprising multiple validation data elements, each of the multiple validation data elements being indicative of a match between the vessel location coordinates and the port locations;
determining a numerical correspondence value between each of the carrier location data elements and a corresponding one of the validation data elements; and
based on the numerical correspondence, identifying discrepancies between the carrier location data and the validation data to automatically detect the inaccuracies in the carrier location data.

In some embodiments, the predefined list of port locations comprises port location coordinates and the match comprises a match between the vessel location coordinates and the port location coordinates.

In some embodiments, further comprising updating the carrier location data to reduce the discrepancies.

In some embodiments, the method further comprises iteratively selecting a port location based on the numerical correspondence.

In some embodiments, the method further comprises maintaining a stack of selected port locations and traversing the stack in two directions to iteratively improve a score of the selected port locations in the stack, wherein the method is recursive to improve the score.

In some embodiments, the method further comprises storing parts of the stack comprising one or more port locations for re-use in a further iteration.

In some embodiments, the method comprises creating a matrix of previously calculated matches, the matrix comprising cells for cell indices and each cell stores a list of pairs of matched elements up to the index of that cell.

In some embodiments, the method further comprises calculating a matching score for multiple elements of the matrix and re-using cells of the matrix for further exploration of other combinations of matching pairs.

In some embodiments, the method comprises applying the method to carrier location data from multiple carriers to match carrier location data elements from a first carrier with carrier location data elements from a second carrier.

In some embodiments, the method further comprises determining a port that the vessel is predicted to reach in the future based on the matching.

In some embodiments, the numerical correspondence is determined based on one or more of
a port code,
country,
distance,
port name, and
date.

In some embodiments, determining the numerical correspondence comprises scoring each possible pair based on correspondence criteria and selecting a pair with the highest score.

In some embodiments, the numerical correspondence is indicative of a similarity between the carrier location data and the validation data.

In some embodiments, the location data elements and validation data elements each have multiple fields, and determining the numerical correspondence comprises determining a scoring indicative of which of the multiple fields match, wherein the scoring comprises different weights associated with each of the multiple fields.

In some embodiments, the numerical correspondence decreases with an increasing time difference between the location data elements and the validation data elements.

In some embodiments, the method further comprises:
generating a threshold number of pairs of a location data element and a validation data element to score each pair according to the numerical correspondence;
caching numerical correspondence for the pairs and re-using the numerical correspondence in later calculations; and
terminating the determining of the numerical correspondence upon determining that further pairs are likely to have lower correspondence.

In some embodiments, the carrier location data has an order of the location data elements, and the method comprises updating the carrier location data by updating the order of the location data elements.

In some embodiments, the method further comprises displaying a map with a route defined by the updated carrier location data and each point on the route is defined by one of the location data elements.

In some embodiments, the method further comprises determining, based on the updated carrier location data one or more of:
estimated time of arrival,
early arrival, and
late arrival.

A computer system comprises a processor configured to:
receive the carrier location data generated by a carrier and comprising multiple location data elements, each of the multiple location data elements being indicative of a port at which the vessel has berthed;
receive historical vessel location data, generated by the vessel using a location sensor on the vessel and comprising vessel location coordinates;
match the historical vessel location data with a predefined list of port locations, to generate validation data comprising multiple validation data elements, each of the multiple validation data elements being indicative of a match between the vessel location coordinates and the port locations;
determine a numerical correspondence value between each of the carrier location data elements and a corresponding one of the validation data elements; and
based on the numerical correspondence, identify discrepancies between the carrier location data and the validation data to automatically detect the inaccuracies in the carrier location data.

### BRIEF DESCRIPTION OF DRAWINGS

FIG. 1 illustrates a tracked vessel.

FIG. 2 illustrates a correspondence between vessel tracking data and carrier data.

FIG. 3 illustrates a method for automatically detecting inaccuracies in carrier location data of a vessel.

FIG. 4 illustrates a computer network.

### DESCRIPTION OF EMBODIMENTS

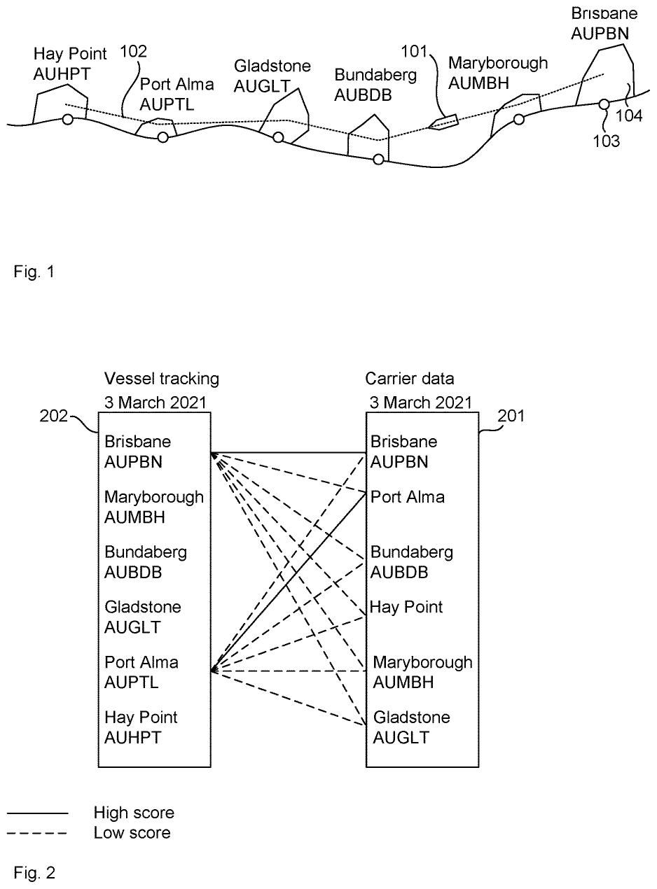

FIG. 1 illustrates a tracked vessel 101 that continuously sends GPS location coordinates as indicated by dots on the vessel track 102. FIG. 1 also shows six different ports where the vessel has berthed, which may be received as a list from an external data provider. Each port has associated location coordinates, such as GPS coordinates. It is now possible to match the vessel GPS coordinates against the port coordinates. This match may be valid if the vessel coordinates are less than a distance threshold away from the port coordinates, such as 5 km. In another example, the port locations comprise multiple berth locations. That is, each berth has respective location coordinates and is associated with one port, such as by comprising a port identifier in the data record for that berth. In that case, it is still possible to match the vessel coordinates with the berth coordinates to determine the port. In that case, the threshold distance may be smaller than in the case of a single port coordinate. So for berth matching, the threshold distance may be 500 m. In yet a further example, the port coordinates comprise data indicative of a port and each port comprises multiple terminals and each terminal comprises multiple berths. So again, by matching the vessel coordinates against the berth coordinates, the port identifier can be determined by traversing through the terminals and the port.

In another example, each port, such as example port 103 (Brisbane), is associated with a port area 104. The port area 104 is determined by clustering historical vessel locations (including vessels other than vessel 101) and then calculating a convex hull including the vessel locations that belong to the clusters. Since stationary vessels generate many GPS locations at or near the same locations, those clusters indicate areas where vessels are stationary because they are anchored or moored, for example. Therefore, each port area 104 can be referred to as “waiting area”. When a vessel location is determined to be within the port area 104, it can be concluded that the vessel has berthed at that corresponding port 103.

Most cargo vessels are operated by a vessel agent, who is responsible for managing the vessel's operation. The vessel agent offers capacity to a carrier, who is responsible for the ocean transport of cargo. The carrier also operates a carrier computer system, which provides access to vessel data for freight forwarders. More particularly, a freight forwarder makes an agreement with the carrier to transport a consignment, such as a container, on a vessel. While the consignment is on board the vessel, the freight forwarder wishes to access vessel location information in order to track the whereabouts of the consignment. To that end, the freight forwarder operates a freight forwarder computer system that connects to the carrier computer system, such as over the internet.

The carrier computer system then provides carrier location data to the freight forwarder computer system. FIG. 2 illustrates the different data sets that are involved including carrier location data 201. The carrier location data 201 comprises an ordered list of entries or elements. Each of the entries is indicative of a port. For example, each entry may include the name of a port, such as “Brisbane AUPBN” or “Port Alma”. It is noted here that the freight forwarder does not have direct access to the vessel agent, so the carrier location data is not the original vessel data from the vessel agent but a modified version of it.

While the carrier location data does provide an indication of a sequence of ports, it is often the case that carrier location data is inaccurate. For example, the port names provided in the carrier location data 201 may not be official port names but may be the name of the city where the port is located. Further, the port names may be missing a standardised port identifier, such an as UNLOCO code. Further, carrier location data may not be based on captured sensor data, such as GPS locations, but on unreliable data sources, such as manual data entry at port offices. As a result, the carrier location data 201 may include inaccuracies that ought to be identified.

Since many freight forwarder computer systems are programmed to use the carrier location data 201, despite its inaccuracies, it would be a technical advantage to have a digital signal, or flag, that indicates that inaccuracies were identified in the carrier location data 201. Such a flag can then be used to change the data processing of the carrier location data 201 at the freight forwarder computer system.

This disclosure provides a method comprising steps of a computer implementation to automatically detect inaccuracies in carrier location data 201. These steps are specifically designed to program a computer in a way to connect to external data sources to obtain additional digital information to find inaccuracies in a range of different circumstances and different types of errors. More particularly, the computer programmed according to this disclosure, connects to a first data source to obtain the carrier location data. The computer then connects to a second data source to obtain further vessel tracking data. The computer then performs the steps of the computer implementation disclosed herein to detect inaccuracies in the carrier location data using the vessel tracking data.

FIG. 2 also illustrates vessel tracking data 202. This vessel tracking data 202 is generated from GPS location data and port areas as described above. More particularly, vessel tracking data 202 is a list of port areas in which the vessel's GPS location has been determined. The list in vessel tracking data 202 is ordered by the time stamp of the GPS location data.

It is now an aim to match the carrier tracking data 201 to the vessel tracking data 202 in order to identify inaccuracies in the carrier location data 201.

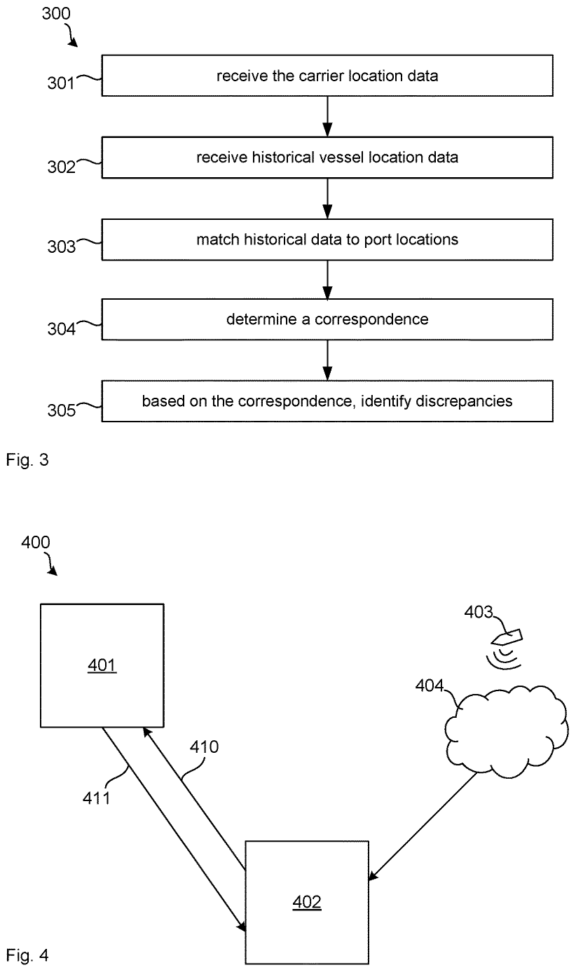

FIG. 3 illustrates a method 300 for automatically detecting inaccuracies in the tracking data 201 of vessel 101. The method is performed by a processor of a computer system, such as the freight forwarder computer system or another computer system that has access to the carrier location data 201 and the vessel tracking data 202. Since the vessel tracking data 202 is used to validate the carrier location data 201, the vessel tracking data 202 is also referred to as “validation data”.

Method 300 commences by the processor receiving 301 the carrier location data generated by the carrier. As described above with reference to FIG. 2, the carrier location data 201 comprises multiple carrier location data elements. Each of the multiple carrier location data elements is indicative of a port at which the vessel has berthed.

Then, the processor receives 302 historical vessel location data, generated by the vessel using a location sensor on the vessel and comprising vessel location coordinates. In one example, this location data is historical AIS data transmitted by the vessel over time.

Processor 302 matches 303 the historical vessel location data with a predefined list of port locations to generate the validation data 202 comprising the multiple validation data elements shown in FIG. 2. For example, the predefined list of port location has geographical positions of berths and the processor 302 determines whether the historical location is within a predefined radius around the berth location. The “berth location” may also be referred to as the “port location” since there is a direct many-to-one relationship between multiple berths and a specific port. If the historical location is within the predefined radius, processor 302 adds a validation data element including the time stamp of the historical location data and a port identifier, such as an UNLOCO code of the berth.

In other words, the processor 302 generates the validation data elements by matching port location coordinates (potentially including berth coordinates) to vessel location coordinates. More particularly, processor 302 may also consider the speed of the vessel that is provided with each historical vessel location. If the speed of the vessel is zero, and the berth location matches, the processor 302 generates one validation data element. The processor 302 then does not generate further validation data elements for the same port/berth until processor 302 determines that the vessel has departed from the port, such as by determining that the vessel has left the port area 104.

Further, the processor determines 304 a numerical correspondence between each of the tracking data elements and a corresponding one of the validation data elements. As shown in FIG. 2, the processor attempts to match one element from the vessel tracking data 202 against multiple elements from the carrier location data 201. The lines indicate the different attempts. A solid line indicates a match, while a dashed line indicates a mismatch.

In the first example element of Brisbane, the first element in vessel tracking data 202 and the first element in carrier data 201 both have the UNLOCO code for the port of Brisbane “AUPBN”. As a result, the match is relatively strong. In the second example of Port Alma, only the vessel tracking data 202 has the UNLOCO code “AUPTL” at position 5, but the port name matches exactly against the port name from the carrier location data 201. As a result, the matching is less strong than for the first example. But still, the processor determines a match. This way, the processor determines a correspondence between each of the tracking data elements 202 and a corresponding one of the validation data elements 201. More particularly, the processor determines a scoring that is indicative of which of the multiple fields match. In the course of that scoring, the processor applies different weights to the different fields. For example, the UNLOCO field has a high weight so a match is significant whereas the port name field has a lower weight so a match is less significant and so on for other fields such as country.

Then, based on the correspondence, the processor identifies 305 discrepancies between the tracking data 202 and the validation data 201 to automatically detect the inaccuracies. The discrepancy may be a difference between the tracking data 202 and the carrier data 201. The discrepancy may be between individual entries, such as incorrect or incomplete port names. In other examples, the discrepancy is in the order of ports, missing or additional port names, or any combination of discrepancies.

The processor may further update the carrier data 201 to reduce the discrepancies. For example, the processor may re-order the entries in the carrier data 201 so that they match the tracking data 202. In other cases, the processor may correct the port names in carrier data 201 or add the UNLOCO codes where they are missing. Further, the processor may add missing port names or delete port names that are present erroneously. As a result, the discrepancies are reduced.

While the example in FIG. 2 is based on UNLOCO codes and port names, there may be further details on which a match is performed. For example, each entry in the tracking data 202 and the carrier data 201 may comprise an indication of a country in which the port is located. In response to the countries matching, the processor assigns a relatively high matching score to those entries. Further, the processor may determine a distance between a port in the tracking data 202 and a port in the carrier data 201 and assign a matching score such that a low distance leads to a high matching score. This way, ports that are close to each other are matched, which is an advantage in cases where two closely located ports are interchanged by mistake. For example, a large city may have two ports, such as a container port and a passenger port. The carrier data 201 may list the passenger port while the tracking data 202 correctly lists the container port. In that case, both ports are close to each other, so processor will find a match between them.

In yet a further example, the processor takes into consideration a date value associate with each port. This is useful where a vessel only berths at one port at a particular date or only at a small number of ports. In that case, the processor assigns a higher matching score to ports with an identical date value.

In another example, the processor generates all possible pairs of entries with the first element of the pair from the tracking data 202 and the second element of the pair being from the carrier data 201. So the processor would generate pairs of:
“Brisbane AUPBN”-“Brisbane AUPBN”
“Brisbane AUPBN”-“Port Alma”
“Brisbane AUPBN”-“Bundaberg AUBDB”, etc.

The processor may have stored a predefined threshold number of pairs and stops the generation of the pairs once the threshold number of pairs is reached. This avoids the generation of an impractically high number of pairs.

The different pairs are indicated as solid and dashed lines in FIG. 2, but not all pairs are shown for clarity. In the example of FIG. 2, every element of the tracking data 202 is paired with every element of the carrier data 201, so a total of 6*6=36 pairs are generated (or up to the threshold). Then, the processor calculates a matching score for each pair. As described above, the first pair listed above would have a relatively high matching score, while the second pair would have a relatively low matching score.

More particularly, the processor first attempts to match the UNLOCO code between the pair. If the UNLOCO code exists in both elements and matches, the processor assigns a high score, such as 100. In response to the UNLOCO codes matching, the processor may then stop with a score of 100 or continue with the potential of adding more points to the score. Further matching strategies may include checking whether both ports are in the same port mapping cluster. The port mapping cluster is determined by the clustering algorithm that determines a port area by finding clusters and calculating a convex hull around those clusters. If both ports are in the same area, they likely match and in response, the processor adds a matching score to that pair, such as 50. Further, the processor matches the country and port name and in response to finding a match in both, add a further matching score, such as 20. Even further, the processor may determine whether the two ports of the pair are less than a distance threshold from each other. In response, the processor adds a further matching score, such as 10.

In the example above, the processor adds different matching scores for the different types of matches. This reflects that some matches are more significant than others. This means that processor first relies on the most significant matches and only if these are not available, falls back to less significant matches. The processor may also adjust the matching score by a time difference. So in some examples, the tracking data 202 and the carrier data 201 comprise time stamps for each element. Then, the processor can calculate a time difference between the two time stamps, such as a time difference in number of days. The processor may then multiply the score by e^{-d} where d is the time difference in days to calculate an adjusted score. So where the time difference is zero, the multiplier is one and would therefore not change the score.

However, as the time difference d increases, the multiplier approaches zero to gradually reduce the matching score.

Once the matching scores for all pairs are calculated, the processor selects the pairs with the highest matching scores. This may be for each element of tracking data 202 separately, so that the processor selects the best of six pairs, or for all pairs so that the processor selects the top six pairs.

Once the highest matching pair or pairs is selected, and the processor has updated the carrier data to reduce inaccuracies, the processor may use the corrected data for a range of applications. For example, the processor may generate a display a map with a route thereon that is defined by the elements of the corrected carrier data. Further, the processor may calculate an estimated time of arrival (ETA) and/or determine that the vessel will arrive late or early. This determination can be useful for planning and automatically controlling port equipment, such as gantry cranes and trucks.

There may be some additional optimisations such as caching all intermediate results (correspondence values) and stopping the calculation of a match set that would have lower score than the current highest score. For example, if there is a high match for one pair of carrier data and tracking data and the correspondence decreases for further pairs with the same carrier data, then it is unlikely that further pairs will reveal a better match. Therefore, calculations can be terminated for this carrier data. This applies vice versa for pairs with the same tracking data. Further, if match scores are not high enough, then a random result may be returned.

While the above example relates to selecting the best match from all pairs, in other examples, processor 302 calculates an overall score for the entire selection of corresponding data elements. Processor 302 may calculate an overall score for every combination of all validation data elements 202 and all carrier location data elements 201 and then select the combination with the lowest score. However, the number of combinations rises quickly and common available computer hardware can only process and store all combinations of up to around 10 different elements in each set. If there are more elements, the number of combinations exceeds available memory resources and practical computation time limits.

Therefore, processor 302 executes a method that utilises a stack concept. In this approach, processor 302 also takes the time difference into account such that even exact matches of locations achieve a low score if the time difference is large (e.g. more than 5 days). So each match can be seen as a probabilistic match. Further, the stack-based approach avoids an exhaustive search. Instead, processor 302 starts with the first validation data element and finds the best match to that location and adds that match to the stack. Then, processor 302 continues with the second validation data element given the first match has already excluded a port from the carrier data and adds the second match to the stack. Processor 302 continues until the last validation data element. Processor 302 can then reverse through the stack and try more combinations at each position in the stack. Processor 302 may store parts of the stack for later use. For example, parts of the stack, including one or more matches, may have perfect matching scores, so processor 302 may not revisit them. This may apply to a large part of the stack and therefore reduce the overall number of pairs dramatically. Those regions of the stack can even be used later when matches before that region or after that region are reconsidered.

Processor 302 may continue to optimise the overall matching score by moving up and down the stack until a termination condition is met. The termination condition may be a maximum number of pairs considered, a maximum processing time reached, a minimum combined score achieved or a minimum threshold improvement between iterations.

In one example, there are four ports A, B, C, D. There are four elements in the carrier data (indicated by lower case ‘c’) Ac, Bc, Cc, Dc in this order. There are five elements in the validation AIS data (indicated by lower case ‘a’) Aa, Ba, Ca, Da, Ea. The first step may then be to find all possible matches with a score above 0, which may result in (Ac,Aa,1), (Bc, Ba,0.5), (Cc,Ca,0.5), (Ac,Ca,0.1).

In a further example, processor 302 may build a collection variable on memory the stores the selected combinations. The collection variable may be a matrix, a dictionary, or other variable. Each element of the collection variable is a list of pairs that are selected for matching. For a matrix the second row and second column may hold (Ac, Aa)(Bc, Ba). Meaning, port A from the carrier is matched with port A from the validation data and similarly for port B. As processor 302 selects matching pairs, processor 302 fills the matrix with further elements. Each cell of the matrix stores a list of pairs of matched elements up to the index of that cell. CLL is carrier port permutations where time is not clear, so for example, for CL=(ABCD) there may be a matrix M initialised as M[5×4]=[ ] assuming there are four items in the carrier data and five items in the validation data. Then, the first cell of matrix M may be M[0,0]=( (Ac,Aa)) and the next cell M[1,0]=((Bc,Aa)). The diagonal cell may be M[1,1]=((Ac,Aa)(Bc,Ba)), which shows how the lists in each cell become longer since each cell contains matching pair up to that index.

As the method proceeds, matches can be skipped and the method finds the best match and stores the best match in M. Finally, method gets the total store in the list as the sum of scores in each match. This does not take into account length of list but only the score. So a longer list can have a better score than a shorter list.

The following pseudocode describes the method according to an embodiment:

```
Retrieve the list of AIS port calls (A) in the date range (AL)
Retrieve the list of carrier port calls (C) matching the filtering criteria
(CL)
Find all possible matches between port calls in AL and CL, and the type and
score of the match :
- same UNLOCO
- different UNLOCO, but meaning the same port
- same country and port name
- close distance
In addition, ETA-ETD range for both port calls must be close enough
Calculate the time difference between matching A and C
Calculate the matching score for each matching A/C pair, using matching type
and time difference
In the end all C in CL will have 0 or more matching A, and vice versa
Generate all possible permutations of ambiguous port calls (CLL)
If the possible number of permutations becomes too high - randomly take only
some of them
For each CL in CLL:
  Create an empty matrix (M) with rows of indexes in AL and columns -
indexes in CL, each cell is the best chain of A/C matching up to those indexes
(inclusive)
  Call Find Best Match (0, −1)
Find Best Match procedure (Ci, Ai):
  if M contains a cell for current Ci and Ai - return it Otherwise:
    Best Matching List of A/C (BML) = empty
    For each possible matching A in C, which index Ai′ > Ai:
      Next Matching List (NML) = Find Best Match (Ci + 1, Ai′)
//Find best matching list skipping current A and C
      Current Matching List (CML) = A/C ++ NML
      If CML.Total Score > BML.Total Score Then
        BML = CML
    If any A matching to C has other C matching to it, or C has no
matching A at all then:
      Fallback Matching List (FML) = Find Best Match (Ci + 1, Ai)
//Find best matching list skipping current C
      If FML.Total Score > BML.Total Score Then
        BML = FML
    Add BML to M
    Return BML
Select best BML among all BML calculated from CLL
In the end BML contains merged pairs of A/C
Add remaining unmerged A and C from AL and CL to BML in their proper positions
(using date range and sequence number)
```

FIG. 4 illustrates a computer network 400 comprising a carrier computer system 401 and a freight forwarder computer system 402, a vessel 403 and a AIS data network 404. The freight forwarder computer system 402 sends a request 410 for carrier data to the carrier computer system 401. In turn, the carrier computer system 401 sends the carrier data 411 to the freight forwarder computer system 402. This carrier data may be conceptually similar to the carrier data 201 shown in FIG. 2. The freight forwarder computer system 402 may request the carrier data repeatedly, which is referred to as a pull, or may receive it automatically from the carrier computer system repeatedly, which is referred to as a push.

Freight forwarder computer system 402 further receives tracking data (conceptually similar to tracking data 202 in FIG. 2), from the AIS data network 404. The tracking data may comprise a list of ports identified to have been visited by vessel 403. In another example, the tracking data is the raw AIS data with GPS locations and the freight forwarder computer system 402 then performs clustering to determine port locations. Consequently, the freight forwarder computer system 402 determines whether the vessel 403 is within a port location to generate the tracking data comprising port names or port identifiers.

Once the carrier data and the tracking data are available, the freight forwarder computer system 402 identifies inaccuracies in the tracking data as described above. The freight forwarder computer system 402 may further host a software application that provides user access to various aspects of freight management. In that software application, the freight forwarder computer system 402 may provide an indication to the user on where inaccuracies were detected in the carrier data. This way, the user can then decide on whether to accept the corrected version of the carrier data after the inaccuracies have been removed or reduced. Further, the freight forwarder computer system 402 may generate a map view for the user and the map view comprises a graphical representation of a route of the vessel according to the corrected carrier data.

As described above, this disclosure provides a method of computerised steps to detect inaccuracies. The specific method steps are applied to carrier data but could be applicable to other type of data. As a result, any downstream systems that rely on or process the carrier data can be alerted in response to an inaccuracy having been determined. The advantage is that the overall system architecture becomes more reliable and robust because inaccuracies are flagged within the data processing. This way, users can more readily rely on the provided data and there is a reduction in the number of wrong decisions that were previously based on inaccurate carrier data. Further, the corrected carrier data can be displayed on a map, for example. That way, a user can visually inspect the location and/or movement of the vessel. Previously, due to the inaccuracies in the carrier data, such a display would have led to user frustration. But now, with the improved method disclose herein, there can be an indication to the user if inaccuracies have been detected in the carrier data.

Further, the disclosed method relies on areas determined by clustering historical locations, such as GPS locations, of other vessels. This is a data-driven approach, which means it can be performed automatically without user input. That is, the method does not require any spatial modelling of these areas. Further, the disclosed method is accurate in detecting areas traversed by the vessel, which means, as a result, that the determination of inaccuracies is robust and accurate.

In a further application, the methods disclosed herein can be used to predict the next port to be visited by the vessel. In that case, processor 302 may merge data in order to predict with some confidence what will be the next port call for the vessel where the cargo is on. This assists users to make better decisions. Multiple carriers may provide port calls, which share cargo on the same vessel. The algorithm disclosed herein can be used to merge all of these lists together to determine, with some confidence, the next port call of the vessel. This can then be used to predict the estimated time of arrival for that vessel.

For prediction, AIS port calls is not yet available because that relies on GPS data. In this case, it is possible to use the same algorithm using future port calls provided by the carrier as an input. There may be multiple chains and the algorithm merges all of them together. Processor 302 may then calculate the mean time of arrival and departure of all the lists and weight them by historical quality.

When analysing historical carrier data, the methods disclosed herein use the AIS data as the ground truth and analyses the quality or accuracy by detecting inaccuracies in the carrier data. When the method is applied to the future, the carrier data is still available but no AIS data exists yet. Therefore, the method compares port calls from the carrier (or vessel operator) to those provided by other carriers. The method operates as disclosed herein and determines discrepancies of data. This can then be used to inform users of the discrepancies and to estimate and forecast related steps, such as planning local transport, pick-up delivery. etc. A user interface may display the information from each carrier and indicates discrepancies. If the carrier data contains discrepancies, a client may want to go back to carrier to correct mistake. The disclosed method can indicate to the client what is going to happen by cross-referencing and validating data from multiple carriers using them as the “validation data” and the “carrier data” in the methods herein.

There is a further advantage in using the disclosed method for merging lists from multiple carriers in that the merging can help to identify times for requesting updates from the vessel operator. In many examples, operators do not push information out from their systems, but instead, the information needs to be requested by a pull request. There is a limit of how often this data can be requested. Therefore, it is important to time those requests based on ETA provided before. So if the ETA to the next port of that vessel is predicted to be on a particular date, it is possible to wait until that date before requesting an update. However, carriers may change the data of the and because no updates are requested, this change occurs unnoticed. However, the disclosed method can match, correlate and cross-reference from different carriers. That is, the method disclosed herein can be used to match elements of lists from multiple carriers and some of these carriers may have the update that was missed before. Accordingly, it is possible to adjust the schedule of when to pull for that information and a adjust process in a timely manner. For example, if another carrier changed the ETA, attempt to match information from other carriers as they may have updated the ETA as well. Then, generate an indication on a user interface to inform the user about the change.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for automatically detecting inaccuracies in carrier location data of a vessel, the method comprising:
receiving the carrier location data generated by a carrier and comprising multiple location data elements, each of the multiple location data elements being indicative of a port at which the vessel has berthed;
receiving historical vessel location data, generated by the vessel using a location sensor on the vessel and comprising vessel location coordinates;
matching the historical vessel location data with a predefined list of port locations, to generate validation data comprising multiple validation data elements, each of the multiple validation data elements being indicative of a match between the vessel location coordinates and the port locations;
determining a numerical correspondence value between each of the carrier location data elements and a corresponding one of the validation data elements; and
based on the numerical correspondence, identifying discrepancies between the carrier location data and the validation data to automatically detect the inaccuracies in the carrier location data.

2. The method of claim 1, wherein the predefined list of port locations comprises port location coordinates and the match comprises a match between the vessel location coordinates and the port location coordinates.

3. The method of claim 1, further comprising updating the carrier location data to reduce the discrepancies.

4. The method of claim 1, wherein the method further comprises iteratively selecting a port location based on the numerical correspondence.

5. The method of claim 4, wherein the method further comprises maintaining a stack of selected port locations and traversing the stack in two directions to iteratively improve a score of the selected port locations in the stack, wherein the method is recursive to improve the score.

6. The method of claim 5, wherein the method further comprises storing parts of the stack comprising one or more port locations for re-use in a further iteration.

7. The method of any one of claim 3, wherein the method comprises creating a matrix of previously calculated matches, the matrix comprising cells for cell indices and each cell stores a list of pairs of matched elements up to the index of that cell.

8. The method of claim 7, wherein the method further comprises calculating a matching score for multiple elements of the matrix and re-using cells of the matrix for further exploration of other combinations of matching pairs.

9. The method of claim 1, wherein the method comprises applying the method to carrier location data from multiple carriers to match carrier location data elements from a first carrier with carrier location data elements from a second carrier.

10. The method of claim 9, wherein the method further comprises determining a port that the vessel is predicted to reach in the future based on the matching.

11. The method of claim 1, wherein the numerical correspondence is determined based on one or more of
a port code,
country,
distance,
port name, and
date.

12. The method of claim 1, wherein determining the numerical correspondence comprises scoring each possible pair based on correspondence criteria and selecting a pair with the highest score.

13. The method of claim 1, wherein the numerical correspondence is indicative of a similarity between the carrier location data and the validation data.

14. The method of claim 13, wherein the location data elements and validation data elements each have multiple fields, and determining the numerical correspondence comprises determining a scoring indicative of which of the multiple fields match, wherein the scoring comprises different weights associated with each of the multiple fields.

15. The method of claim 1, wherein the numerical correspondence decreases with an increasing time difference between the location data elements and the validation data elements.

16. The method of claim 1, wherein the method further comprises:
generating a threshold number of pairs of a location data element and a validation data element to score each pair according to the numerical correspondence;
caching numerical correspondence for the pairs and re-using the numerical correspondence in later calculations; and
terminating the determining of the numerical correspondence upon determining that further pairs are likely to have lower correspondence.

17. The method of claim 1, wherein the carrier location data has an order of the location data elements, and the method comprises updating the carrier location data by updating the order of the location data elements.

18. The method of claim 1, wherein the method further comprises displaying a map with a route defined by the updated carrier location data and each point on the route is defined by one of the location data elements.

19. The method of claim 1, wherein the method further comprises determining, based on the updated carrier location data one or more of:
estimated time of arrival,
early arrival, and
late arrival.

20. A computer system comprising a processor configured to:
receive the carrier location data generated by a carrier and comprising multiple location data elements, each of the multiple location data elements being indicative of a port at which the vessel has berthed;
receive historical vessel location data, generated by the vessel using a location sensor on the vessel and comprising vessel location coordinates;
match the historical vessel location data with a predefined list of port locations, to generate validation data comprising multiple validation data elements, each of the multiple validation data elements being indicative of a match between the vessel location coordinates and the port locations;
determine a numerical correspondence value between each of the carrier location data elements and a corresponding one of the validation data elements; and
based on the numerical correspondence, identify discrepancies between the carrier location data and the validation data to automatically detect the inaccuracies in the carrier location data.
